(19) United States
(12) Patent Application Publication
(10) Pub. No.: US 2005/0246330 A1
(43) Pub. Date: Nov. 3, 2005

(54) System and method for blocking key selection

(76) Inventors: Phan H. Giang, Downingtown, PA (US); Sathyakama Sandilya, Fontainebleau (FR); William A. Landi, Devon, PA (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/070,463

(22) Filed: Mar. 2, 2005

Related U.S. Application Data
(60) Provisional application No. 60/550,876, filed on Mar. 5, 2004.

(51) Int. Cl. G06F 17/30

(52) U.S. Cl. 707/3

(57) ABSTRACT

A method for determining a blocking key includes selecting, randomly, a plurality of record pairs from a pair space that can be formed from a plurality of records of a database, scoring the plurality of record pairs, and comparing a score of each of the plurality of record pairs to a threshold to determine a label for each record pair. The method further includes comparing, character-by-character, each field of each of the plurality of record pairs, wherein a result of the comparison is a binary vector entered in a binary vector matrix, and determining a blocking key based on the binary vector matrix.

This application claims priority to U.S. Provisional Application Ser. No. 60/550,876, filed on Mar. 5, 2004, which is herein incorporated by reference in its entirety.

### BACKGROUND OF THE INVENTION

1. Technical Field

The present invention relates to record linking, and more particularly to a system and method for finding blocking keys for record linkage problems.

2. Discussion of Related Art

Record linkage is the process of identifying multiple entries in a database that represent the same entity. This is achieved by comparing pairs of records and deciding whether or not each pair corresponds to the same entity. In real world databases, it is prohibitively expensive to compare all possible pairs of records, e.g., 2 trillion comparisons for a 2 million record database. To make the problem more computationally tractable, the database is broken up into smaller databases called “blocks” using “blocking keys” such that most records pairs likely to represent the same entity will fall in the same block.

The blocking key is chosen as a set of character positions in the record. The quality of a blocking key is measured by the number of comparisons that result in detecting duplicates, and the number of comparisons that did not. Generally, blocking keys are selected by a domain expert with the aid of accumulated domain knowledge.

Blocking is a mechanism used in record linkage to reduce the number of pair comparisons. A database (set of records) is divided into smaller blocks by blocking key values. Instead of comparing every possible pair that can be formed by records in the database, one will need to compare those pairs whose records belong to the same block.

A blocking key is a pre-defined set of positions. A good blocking key increases the likelihood that duplicate records are in the same block. Existing methods for selecting blocking keys include manual selection based on intuition and statistical analysis. These methods are slow, complex and costly because the set of possible blocking keys is large. These methods do not ensure finding a good blocking key.

Therefore, a need exists for a system and method for automatic selection of blocking keys.

### SUMMARY OF THE INVENTION

According to an embodiment of the present disclosure, a method for determining a blocking key comprises selecting, randomly, a plurality of record pairs from a pair space that can be formed from a plurality of records of a database, scoring the plurality of record pairs, and comparing a score of each of the plurality of record pairs to a threshold to determine a label for each record pair. The method further comprises comparing, character-by-character, each field of each of the plurality of record pairs, wherein a result of the comparison is a binary vector entered in a binary vector matrix, and determining a blocking key based on the binary vector matrix.

The selected record pairs constitute about 1/1,000 of the plurality of records of the database.

A record pair with a score exceeding a threshold is given a first labeled and a record pair with a score less than a threshold is given a second label, wherein the threshold is a numerical expression of a combination of a sub-set of fields of the database. The score is a proxy for a ground truth.

The character-by-character comparison is made for each field and the binary vector has a length, wherein the length is a sum of field lengths. The binary vector matrix comprises rows corresponding to positions within each field and each row corresponds to the comparison of a record pair.

According to an embodiment of the present disclosure, a program storage device is provided, readable by machine, tangibly embodying a program of instructions executable by the machine to perform method steps for determining a blocking key. The method comprises selecting, randomly, a plurality of record pairs from a pair space that can be formed from a plurality of records of a database, scoring the plurality of record pairs, comparing a score of each of the plurality of record pairs to a threshold to determine a label for each record pair, comparing, character-by-character, each field of each of the plurality of record pairs, wherein a result of the comparison is a binary vector entered in a binary vector matrix, and determining a blocking key based on the binary vector matrix.

According to an embodiment of the present disclosure, a record linkage method comprises determining, automatically, at least one blocking key from a sub-set of a pool of record pairs of a database, filtering the pool of record pairs using the automatically determined blocking key, scoring a plurality of record pairs filtered by the blocking key, and reporting filtered record pairs having a desirable score.

### BRIEF DESCRIPTION OF THE DRAWINGS

Preferred embodiments of the present invention will be described below in more detail, with reference to the accompanying drawings:

FIG. 1 is a flow chart of a method for record linkage according to an embodiment of the present disclosure;

FIG. 2 is a flow chart of a method for automatic blocking key selection according to an embodiment of the present disclosure;

FIG. 3 is a flow chart of a machine learning method according to an embodiment of the present disclosure;

FIG. 4 is a flow chart of a logic circuit design method according to an embodiment of the present disclosure;

FIG. 5 is a flow chart of an optimization method according to an embodiment of the present disclosure; and

FIG. 6 is a diagram of a system according to an embodiment of the present disclosure.

### DETAILED DESCRIPTION OF PREFERRED EMBODIMENTS

According to an embodiment of the present disclosure, a method for record linkage includes providing a pool of record pairs (e.g., 2*10¹² pairs) 101. At least one blocking key, determined automatically, filters the pool of record pairs 102 to a sub-set of record pairs (e.g., 10⁹ record pairs) 103. The sub-set of record pairs is scored 104. Record pairs scored higher than a threshold are reported 105. Blocking keys are determined prior to record linkage 106.

While the example proposes a reduction from 2*10¹² record pairs to 10⁹ record pairs, different initial pool sizes may be provided. The reduction ratio (e.g., about 1/1,000) is expected. The hypothetical initial 2*10¹² record pairs correspond to a database of approximately 2 million records. The size of the sub-set of record pairs depends on processing speed (e.g., computer capability) and a time limit allowed for record linkage task (e.g., 8 hrs, 1 day, 3 days).

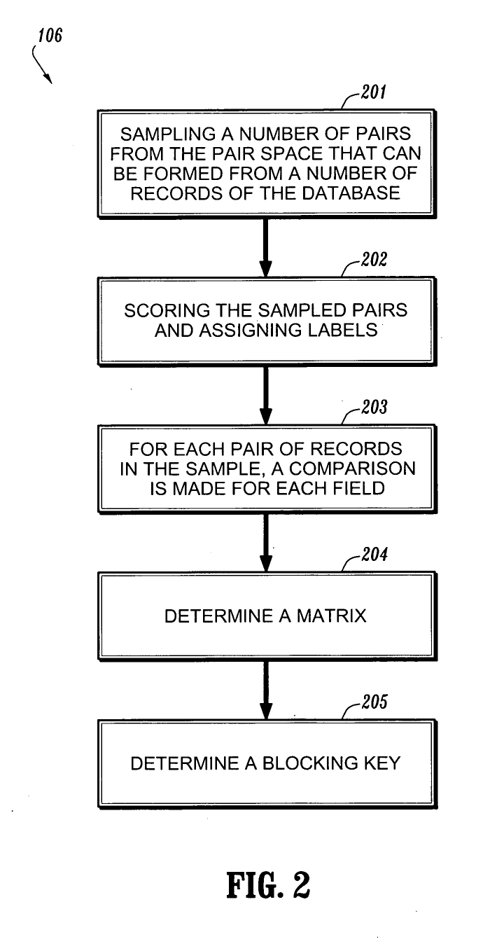

According to an embodiment of the present disclosure, blocking key selection (see FIG. 2) can be automated/optimized with respect to a given scoring method. The scoring method and blocking key selection are therefore related.

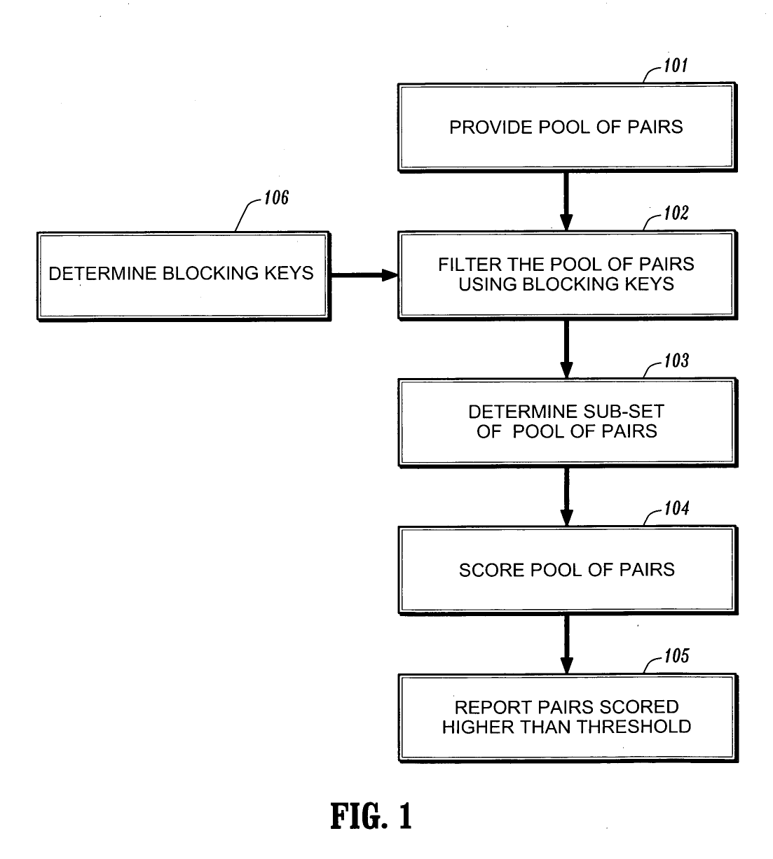

According to an embodiment of the present disclosure, referring to FIG. 2, a method for selecting a blocking key includes randomly selecting a number (n) pairs from the pair space (e.g., the pair space provided; FIG. 1, 101) that can be formed from a number of records (N) of the database 201. The number n is determined by a formula to ensure the estimate is reliable, for example, 5% of the initial pool. The n pairs are scored using a scoring method and labeled (e.g., match/no-match) according to a threshold 202.

A scoring method scores a number (e.g., “n”) of randomly selected record pairs from the initial pool. The scoring method generates a pool of data. Each pair of records scored produces a Boolean vector representing match status (e.g., matched or unmatched) at corresponding positions and a score or label. Based on the pool of data, various optimization techniques (e.g., machine learning, Boolean optimization, linear/integer programming) can be used to derive the blocking keys.

Those pairs with a score exceeding a threshold are labeled 1. Those with a score less than the threshold are labeled 0. The threshold may be, for example, a combination of a sub-set of fields that are determined to match. For example, two records are compared across multiple fields, and the similarity of the two records is evaluated as a function of an application of a set of rules and corresponding weights associated with each field, resulting in the assignment of a similarity score, e.g., between 0 and 100. If the score is greater than the threshold, e.g., 65, then the pair is deemed a match, e.g., labeled 1.

A score given by a scoring method is taken as proxy for the ground truth (duplicate/non-duplicate). For each pair (R1,R2) of records in the sample, a character-by-character comparison is made for each field 203, for example, comparing each character in a pair of name fields. The result is a binary vector V of length m, where m is a sum of field lengths. The value V[k]=0 if the k-th character of record R1 is different from the k-th character of record R2. V[k]=1 if k-th character of record R1 is the same as the k-th character of record R2. The position can be specified from the left or from the right. The result is a 0/1 matrix M of size n times (m+1) where the number of rows is the sample size n and number of columns is length of a standardized record plus one for label 204. Given the matrix M, the blocking keys can be determined 205. Rows of the matrix M correspond to field positions; each row is obtained from a pair by comparing corresponding field positions on a character-by-character basis.

The determined blocking keys are implemented in a record linking method (see for example, FIG. 1). The blocking keys may be determined by, for example, a machine learning method, a logic circuit design method, or an optimization method. Determined blocking keys may be manually modified.

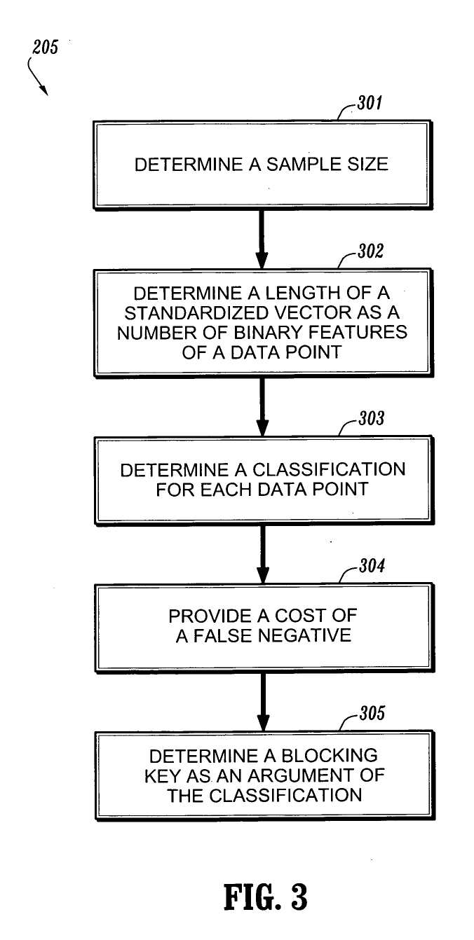

Referring to FIG. 3, a machine learning method may include determining a number of data points as the size of a sample (n) 301. Each data point has m binary features, where m is a length of standardized vector 302. A label for each data point is determined as a classification given by a scoring method 303 (e.g., 0/1). The ratio of the cost of a false negative over the cost of a false positive is large 304. Determining an explicit form of the classification, wherein arguments of the classification are a blocking key 305. It should be noted that other machine learning methods may be implemented, such as a maximum likelihood method.

Machine learning is a special case of optimization. For example, from an optimization point of view, a desirable blocking key of length “k” is determined. “Desirable” may be defined as a maximum numbers of pairs correctly blocked by the key. The key is true for a pair that has label 1 or the key is false for a pair that has label 0.

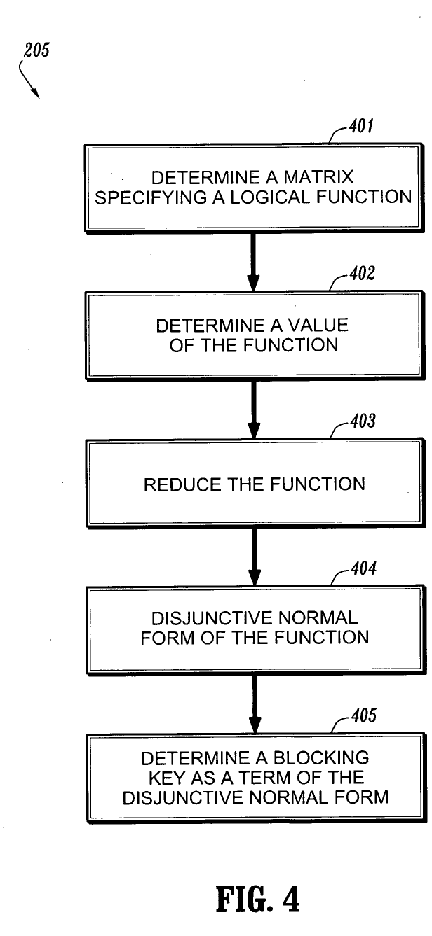

Referring to FIG. 4, a logic circuit design includes, determining a matrix M that specifies a logical (Boolean) function that takes m arguments that correspond to first m columns of the matrix 401. The value of the function is given in the last column of matrix M 402. The Boolean function is simplified 403, the resulting function is a logic expression E in disjunctive normal form (DNF) 404. Each blocking key corresponds to a term of E 405.

For the logic circuit design, the Boolean matrix M can be viewed as a Boolean function. A simplest equivalent Boolean function in DNF form is sought. This function gives a set of blocking keys.

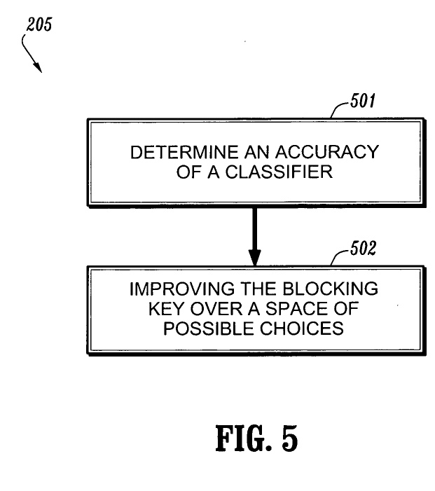

Referring to FIG. 5, an optimization method includes determining an accuracy measure of a previously determined classifier 501. The accuracy measure corresponds to the quality of a blocking key. The quality of the blocking key is explicitly optimized over the space of possible choices using linear/mixed integer programming 502.

It is to be understood that a method for blocking key selection according to an embodiment of the present disclosure may be implemented in various forms of hardware, software, firmware, special purpose processors, or a combination thereof. In one embodiment, a method for blocking key selection may be implemented in software as an application program tangibly embodied on a program storage device. The application program may be uploaded to, and executed by, a machine comprising any suitable architecture.

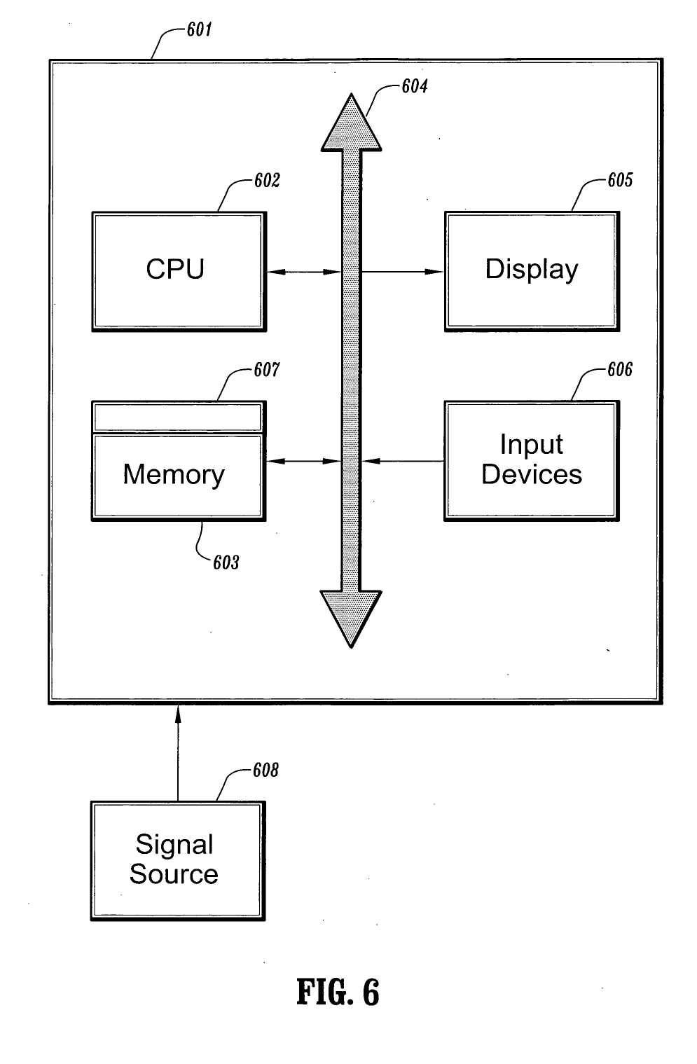

Referring to FIG. 6, according to an embodiment of the present disclosure, a computer system 601 for implementing a method for blocking key selection can comprise, inter alia, a central processing unit (CPU) 602, a memory 603 and an input/output (I/O) interface 604. The computer system 601 is generally coupled through the I/O interface 604 to a display 605 and various input devices 606 such as a mouse and keyboard. The support circuits can include circuits such as cache, power supplies, clock circuits, and a communications bus. The memory 603 can include random access memory (RAM), read only memory (ROM), disk drive, tape drive, etc., or a combination thereof. A method for blocking key selection can be implemented as a routine 607 that is stored in memory 603 and executed by the CPU 602 to process the signal from the signal source 608. As such, the computer system 601 is a general purpose computer system that becomes a specific purpose computer system when executing the routine 607 of the present disclosure.

The computer platform 601 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present disclosure provided herein, one of ordinary skill in the related art will be able to contemplate these and similar implementations or configurations of the present invention.

Having described embodiments for a system and method for determining a blocking key for record linkage problems, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method for determining a blocking key comprising:
selecting, randomly, a plurality of record pairs from a pair space that can be formed from a plurality of records of a database;
scoring the plurality of record pairs;
comparing a score of each of the plurality of record pairs to a threshold to determine a label for each record pair;
comparing, character-by-character, each field of each of the plurality of record pairs, wherein a result of the comparison is a binary vector entered in a binary vector matrix; and
determining a blocking key based on the binary vector matrix.

2. The method of claim 1, wherein the selected record pairs constitute about 1/1,000 of the plurality of records of the database.

3. The method of claim 1, wherein a record pair with a score exceeding a threshold is given a first labeled and a record pair with a score less than a threshold is given a second label, wherein the threshold is a numerical expression of a combination of a sub-set of fields of the database.

4. The method of claim 3, wherein the score is a proxy for a ground truth.

5. The method of claim 1, wherein the character-by-character comparison is made for each field and the binary vector has a length, wherein the length is a sum of field lengths.

6. The method of claim 1, wherein the binary vector matrix comprises rows corresponding to positions within each field and each row corresponds to the comparison of a record pair.

7. A program storage device readable by machine, tangibly embodying a program of instructions executable by the machine to perform method steps for determining a blocking key, the method steps comprising:
selecting, randomly, a plurality of record pairs from a pair space that can be formed from a plurality of records of a database;
scoring the plurality of record pairs;
comparing a score of each of the plurality of record pairs to a threshold to determine a label for each record pair;
comparing, character-by-character, each field of each of the plurality of record pairs, wherein a result of the comparison is a binary vector entered in a binary vector matrix; and
determining a blocking key based on the binary vector matrix.

8. The method of claim 7, wherein the selected record pairs constitute about 1/1,000 of the plurality of records of the database.

9. The method of claim 7, wherein a record pair with a score exceeding a threshold is given a first labeled and a record pair with a score less than a threshold is given a second label, wherein the threshold is a numerical expression of a combination of a sub-set of fields of the database.

10. The method of claim 9, wherein the score is a proxy for a ground truth.

11. The method of claim 7, wherein the character-by-character comparison is made for each field and the binary vector has a length, wherein the length is a sum of field lengths.

12. The method of claim 7, wherein the binary vector matrix comprises rows corresponding to positions within each field and each row corresponds to the comparison of a record pair.

13. A record linkage method comprising:
determining, automatically, at least one blocking key from a sub-set of a pool of record pairs of a database;
filtering the pool of record pairs using the automatically determined blocking key;
scoring a plurality of record pairs filtered by the blocking key; and
reporting filtered record pairs having a desirable score.

14. The method of claim 13, wherein determining, automatically, at least one blocking key comprises selecting, randomly, a plurality of record pairs from the pool of record pairs of the database.

15. The method of claim 14, further comprising scoring the randomly selected plurality of record pairs.

16. The method of claim 15, further comprising comparing a score of each of the randomly selected plurality of record pairs to a threshold to determine a label for each record pair.

17. The method of claim 16, further comprising comparing, character-by-character, each field of each of the randomly selected plurality of record pairs, wherein a result of the comparison is a binary vector entered in a binary vector matrix.

18. The method of claim 17, further comprising determining a blocking key based on the binary vector matrix.

19. The method of claim 18, wherein the determination is made according to one of a machine learning method, a logic circuit method and an optimization of an existing blocking key.
